(19) United States
(12) Patent Application Publication
(10) Pub. No.: US 2006/0183586 A1
(43) Pub. Date: Aug. 17, 2006

(54) Automatic chain tensioner

(75) Inventors: John S. Hayward, Torrington, CT (US); Thomas R. Bober, Amston, CT (US); Daniel R. McLarty, Burlington, CT (US); Walter Peter Waskiewicz, North Canton, OH (US)

Correspondence Address: MICHAEL BEST & FRIEDRICH, LLP, 100 E WISCONSIN AVENUE, MILWAUKEE, WI, 53202, US

(73) Assignee: Timken US Corporation, Torrington, CT (US)

(21) Appl. No.: 11/056,071

(22) Filed: Feb. 11, 2005

(51) Int. Cl. F16H 7/12; F16H 7/18; F16H 7/14

(52) U.S. Cl. 474/136; 474/140; 474/138; 474/117

(57) ABSTRACT

A chain tensioner comprising a support member configured to support a stop bar for axial movement. A ratchet engages the support bar and is configured to permit axial movement of the stop bar in a first direction and prevent axial movement of the stop bar in a second, opposite direction. A shuttle assembly including a tensioning wheel is interconnected to the stop bar such that the shuttle assembly is axially moveable relative to the stop bar over a limited range of motion. A biasing member is configured to bias the shuttle assembly in the second direction.

### BACKGROUND

The present invention relates to a chain tensioner. More particularly, the present invention relates to a chain tensioner that automatically adjusts the slack in a drive chain as the chain stretches over its design life.

In a drive chain system where power is transferred from one sprocket to another via a chain it is desired to maintain a specific range of slack in the chain in order to prevent excessive static loading of the sprocket support bearings via an overly tight adjustment, and to minimize noise and limit backlash in the chain system due to an overly loose adjustment. As the chain is operated over its life, wear takes place that has the effect of lengthening the chain, which causes the slack in the drive chain system to increase. If the amount of slack in the chain is not periodically checked and adjusted via a routine manual maintenance procedure, the drive chain system will become noisy and exhibit excessive backlash as a result of high slack. If the chain is adjusted improperly during the maintenance procedure, it can be set incorrectly, either too tight or too loose, resulting in the loading, noise and backlash conditions described above.

### SUMMARY

The present invention provides a chain tensioner comprising a support member configured to support a stop bar for axial movement. A ratchet engages the support bar and is configured to permit axial movement of the stop bar in a first direction and prevent axial movement of the stop bar in a second, opposite direction. A shuttle assembly including a tensioning wheel is interconnected to the stop bar such that the shuttle assembly is axially moveable relative to the stop bar over a limited range of motion. A biasing member is configured to bias the shuttle assembly in the second direction.

### BRIEF DESCRIPTION OF THE DRAWINGS

FIG. 1 is a front elevation view of a drive chain assembly incorporating a chain tensioner that is a first embodiment of the present invention.

FIG. 2 is an isometric view, in partial section, of the chain tensioner of FIG. 1.

FIGS. 3-7 are front elevation views, in partial section, of the adjustment assembly of the chain tensioner of FIG. 1 illustrating operation of the adjustment assembly.

FIG. 8 is an isometric view of a chain tensioner that is an alternate embodiment of the present invention.

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

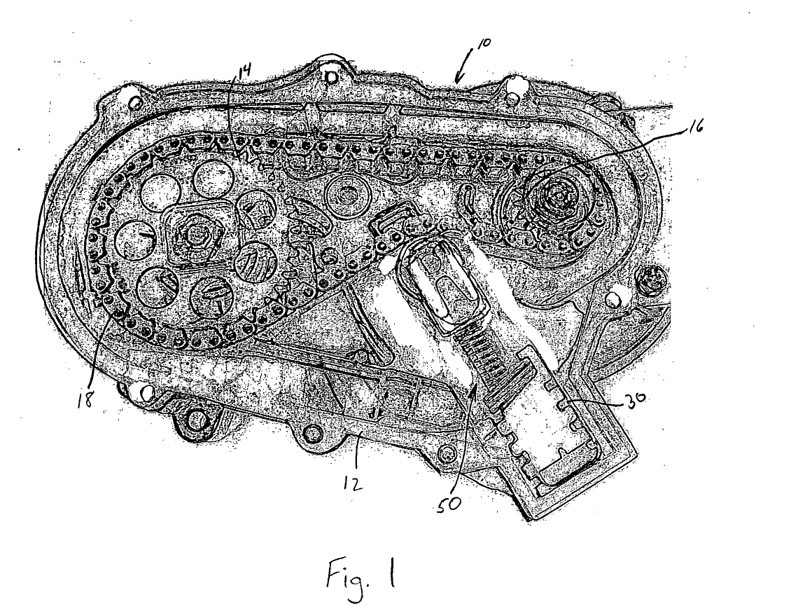

Referring to FIG. 1, an illustrative drive chain assembly 10 is shown. The drive chain assembly 10 includes a housing 12 in which a pair of sprockets 14 and 16 are positioned. A drive chain 18 is looped around the sprockets 14, 16 to transfer power from one of the sprockets to the other sprocket. To maintain a desired range of slack on the drive chain 18, a chain tensioner 50 is positioned in the housing 12 with a tensioning wheel 110 in contact with the drive chain 18.

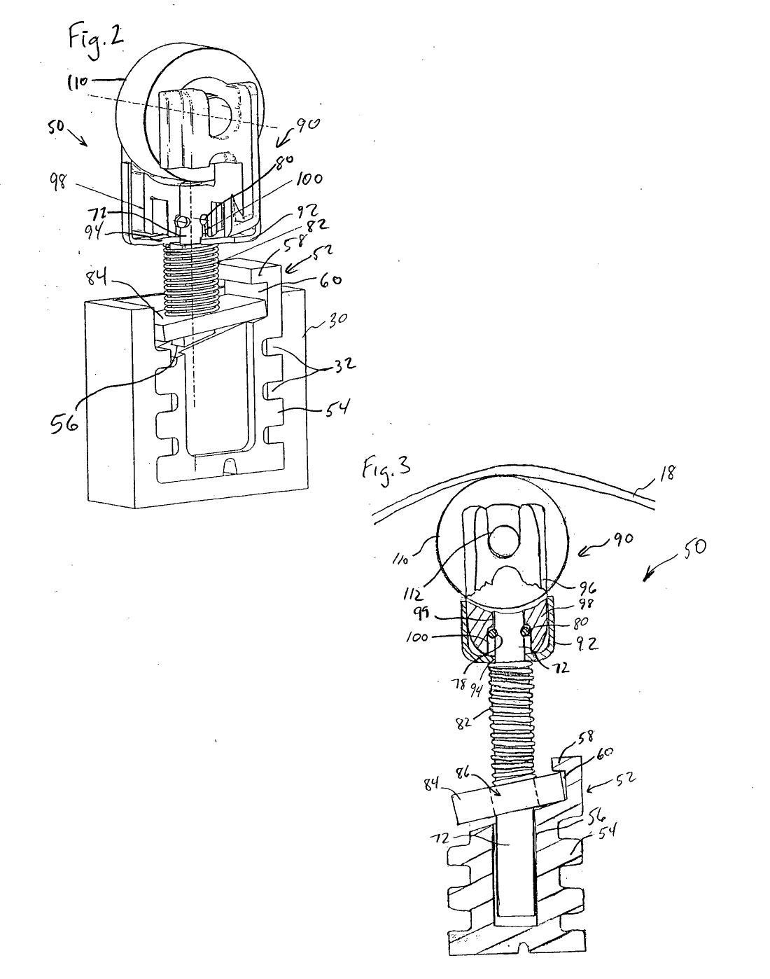

Referring to FIGS. 2 and 3, the chain tensioner 50 includes a support body 52 configured to be fixed in the housing 12. In the current embodiment, the support body 52 has a plurality of ribs 54 configured to mate with a complementary set of ribs 32 in a retaining block 30 in the housing 12. Other means of securing the chain tensioner 50 within the housing 12 may also be utilized. The support body 52 includes a bore 56 in which a stop bar 72 is received. The stop bar 72 is axially moveable within the bore 56. The bore 56 may be provided with a shoulder (not shown) adjacent to the opening in to the bore 56 to limit the extent of axial movement.

The support body 52 also includes a shoulder 58 spaced from the main portion of the body 52 to define a cavity 60 configured to receive an end of the ratchet 84. The cavity 60 is configured such that the ratchet 84 can pivot therein over a limited range, but is generally prevented from axial movement. The ratchet 84 is a generally rectangular bar with a central bore 86 through which the stop bar 72 passes. The central bore 86 has a configuration that complements the geometry of the stop bar 72. In the preferred embodiment, the stop bar 72 and central bore 86 both have a rectangular configuration with the central bore 86 having a close fit about the stop bar 72.

The opposite end of the stop bar 72 is connected to a tensioning wheel 110 via a shuttle assembly 90. The shuttle assembly 90 includes a frame member 92 with a pair of legs 96 extending on opposed sides of the tensioning wheel 110. An axle 112 extends through the tensioning wheel 110 and is supported by the legs 96 to support the tensioning wheel 110. The frame member 92 has an opening 94 configured to receive the stop bar 72. The stop bar 72 extends through the frame opening 94 in to a shuttle body 98 within the frame member 92. The shuttle body 92 has a bore 99 configured to receive the stop bar 72. A portion of the bore 99 has a larger diameter to define a stop ring travel area 100 within the shuttle body 98. The stop bar 72 has a circumferential groove 78 configured to receive a stop ring 80. The stop ring 80 has a diameter larger than the diameter of the stop bar 72 and is limited to travel within the travel area 100 defined between the frame member 92 and the shuttle body 98. While a stop ring 80 provides the desired contact within the travel area, other stop members may be provided. For example, the stop bar 72 may be formed with an integral shoulder or opposed radial tabs. Alternatively, a stop pin may be positioned through and secured in a transverse hole through the stop bar. An adjuster spring 82 is positioned about the stop bar 72 and extends between the ratchet 84 and an outside surface of the frame member 92.

Having described the components of the preferred chain tensioner 50, its operation will now be described with reference to FIGS. 3 through 7. FIG. 3 illustrates an initial position of the chain tensioner 50. The stop bar 72 is positioned radially outward a distance such that the tensioning wheel 110 provides the desired tension to the drive chain 18 and the stop ring 80 is positioned in the radially outward extent of the travel area 100. The adjuster spring 82 maintains the desired tension on the shuttle frame 92 such that the tensioning wheel 110 applies the desired tension to the drive chain 18. The stop bar 72 is prevented from traveling radially inward as the inward force causes the ratchet bore 86 edges to clutch the stop bar 72 with the inward force increasing the clamping load that the ratchet 84 exerts on the stop bar 72, thereby locking it in place.

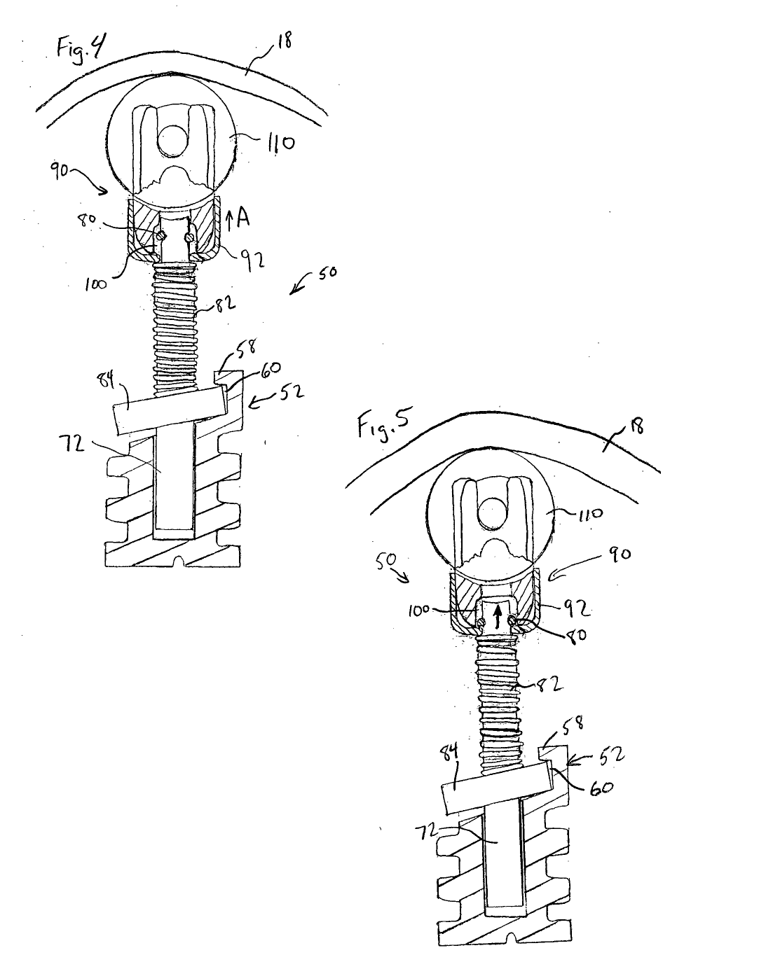

Referring to FIG. 4, as the drive chain 18 wears and its length increases, the adjuster spring 82 exerts the desired tension force on the shuttle assembly frame member 72. The shuttle frame member 92, and thereby the tensioning wheel 110, is free to move radially outward, as indicated by the arrow A, with the stop ring 80 moving within the travel area 100. The adjuster spring 82 maintains the desired tension on the shuttle assembly 90 which in turn maintains the desired tension on the drive chain 18.

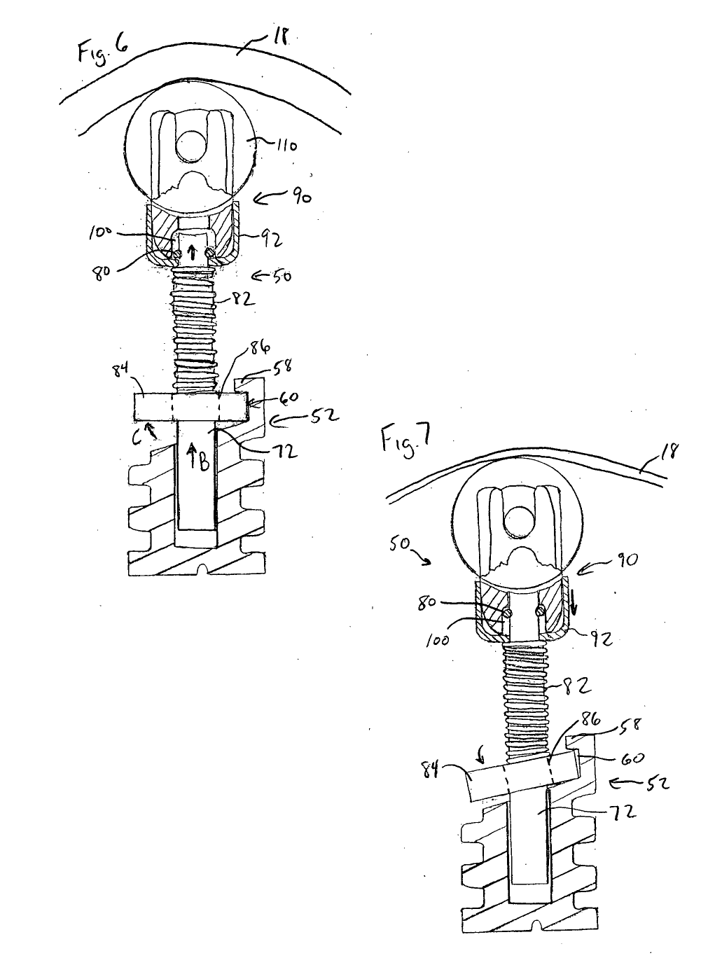

Referring to FIG. 5, eventually the shuttle assembly 90 moves radially outward a distance equal to the length of the travel area 100. At this point, the shuttle frame member 92 contacts the stop ring 80. The adjuster spring 82 force on the frame member 92 is transmitted to the stop ring 80 and thereby to the stop bar 72. The adjuster spring 82 is therefore providing a radially outward force on the stop bar 72 as indicated by the arrow B in FIG. 6. The radially outward force on the stop bar 72 causes the ratchet 84 to rotate as indicated by arrow C. Rotation of the ratchet 84 removes the clamping force of the ratchet bore 86 on the stop bar 72, thereby allowing the stop bar 72 to move radially outward due to the adjuster spring 82 force exerted thereon. The stop bar 72 moves radially outward until the stop ring 80 reaches the radially outer extent of the travel area 100 as illustrated in FIG. 7. Once the stop ring 80 reaches the radially outer extent, the force causes an inward force as indicated by arrow D, thereby causing the ratchet 84 to rotate back to the lock positioning with the stop bar 72 clamped within the ratchet bore 86. The chain tensioner assembly 50 is again positioned as in the initial setup described with respect to FIG. 3. This adjustment process occurs continuously, requires no external power source, and eliminates the normal manual adjustment maintenance procedure.

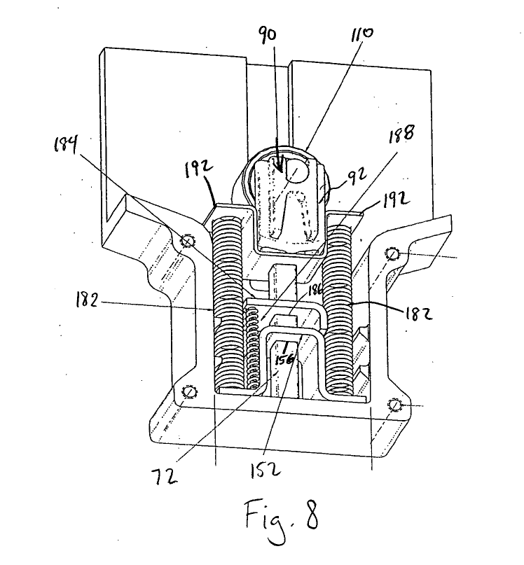

Referring to FIG. 8, a chain tensioner 150 that is an alternate embodiment of the present invention is shown. The chain tensioner 150 is similar to the previous embodiment and includes a shuttle assembly 90 connected to a stop bar 72. The shuttle assembly 90 operates in the same manner as described with respect to the previous embodiment. In the present embodiment, the adjuster springs 182 are positioned on opposed sides of the stop bar 72 and provide the adjuster spring 182 force to shoulders 192 extending from the shuttle frame 92. The support body is replaced by a support bracket 152 with a bore 156 configured to receive the stop bar 72. The ratchet 184 includes a ratchet bore 186 through which the stop bar 72 passes. The ratchet 184 includes a ratchet spring 188 configured to bias the ratchet 184 to the lock positioning in which the stop bar 72 is clamped within the ratchet bore 186. The adjuster spring 182 force is greater than the ratchet spring 188 such that once the shuttle assembly 90 reaches the extent of independent travel, the adjuster spring 182 force will cause the ratchet 184 to rotate to release the clamping force and allow the stop bar 72 to move radially outward.

What is claimed is:

1. A chain tensioner comprising:
a support member configured to support a stop bar for axial movement;
a ratchet engages the support bar and configured to permit axial movement of the stop bar in a first direction and prevent axial movement of the stop bar in a second, opposite direction;
a shuttle assembly supporting a tensioning wheel, the shuttle assembly being interconnected to the stop bar such that the shuttle assembly is axially moveable relative to the stop bar over a limited range of motion; and
a biasing member configured to bias the shuttle assembly in the second direction.

2. The chain tensioner of claim 1 wherein the biasing member is a spring and the spring is coaxial with the stop bar.

3. The chain tensioner of claim 1 wherein the biasing member is a pair of springs positioned on opposed sides of the stop bar.

4. The chain tensioner of claim 1 wherein the ratchet includes a bar having a through bore, the through bore having a configuration complementary to a geometric configuration of the stop bar.

5. The chain tensioner of claim 4 wherein when a force is applied to the stop bar in the first direction, the stop bar is crimped within the through bore and when a force is applied to the stop bar in the second direction, the ratchet rotates such that the through bore is aligned with the stop bar and allows axial motion thereof.

6. The chain tensioner of claim 4 wherein the stop bar has a rectangular geometry and the through bore has a rectangular configuration.

7. The chain tensioner of claim 1 wherein the stop bar has a stop member defined at an end of the stop bar received within shuttle assembly.

8. The chain tensioner of claim 7 wherein the stop member is positioned within a first bore within the shuttle assembly, the first bore defining the limited range of motion of the shuttle assembly relative to the stop bar.

9. The chain tensioner of claim 7 wherein the stop ring has a circumferential groove and the stop member includes a stop ring received in the circumferential groove.

10. The chain tensioner of claim 7 wherein the stop ring has a transverse hole and the stop member includes a pin extending through the transverse hole.

11. The chain tensioner of claim 1 wherein the support member includes a cavity configured to receive the ratchet and allow the ratchet to pivot over a limited range, but generally prevent axial movement of the ratchet.

12. The chain tensioner of claim 1 further comprising a secondary biasing member configured to bias the ratchet to a lock position.
